(19) United States
(12) Patent Application Publication
(10) Pub. No.: US 2008/0302547 A1
(43) Pub. Date: Dec. 11, 2008

(54) Handle, Lifting Spindle Arrangement, and Method for the Production of a Handle

(76) Inventor: Daniel Vergara, Madrid (ES)

Correspondence Address: Joel S. Carter;Patent Department, Deere & Company, 1 John Deere Place, Moline, IL, 61265, US

(21) Appl. No.: 11/630,189

(22) PCT Filed: Jul. 1, 2005
(86) PCT No.: PCT/EP05/53125

§ 371 Date: Dec. 17, 2007

(30) Foreign Application Priority Data
Jul. 3, 2004 (DE) 10 2004 032 312.7

(51) Int. Cl. A01B 59/00; B21D 31/00

(52) U.S. Cl. 172/677; 72/379.2

(57) ABSTRACT

A handle (10) for turning a rod- or tube-formed turning corpus (54), a lift link assembly (52) and a method for producing said handle (10) is described. The handle (10) comprises deformed portions (26, 28, 30) extending parallel to an axis (12) and forming at least partially a hollow space (42, 44, 46) around the axis (12). The hollow spaces (42, 44, 46) are used for engaging with a turning corpus (54). By means of a cut-out (48) formed on the handle (10) and a protrusion (62) formed on the turning corpus (54), a torque proof connection between handle (10) and turning corpus (54) is given by engaging said cut-out (48) with said protrusion (62). It is proposed to form the deformed portions (26, 28, 30) along the axis (12) one after another, wherein at least one deformed portion (26, 28, 30) is contrarily deformed with respect to an adjacent deformed portion (26, 28, 30).

Such a handle (12) can be used for adjusting a lift link assembly (52), for example on agricultural implements.

The invention pertains to a handle with bulges shaped parallel to an axis, which at least partially form a cavity around the axis. Moreover, a lifting spindle arrangement with a handle in accordance with the invention and a method for the production of such a handle are proposed.

Lifting spindles are known in the state of the art, which, particularly with three-point suspension devices, are used for agricultural equipment. By rotating a threaded rod (spindle) that meshes with one or two adjustment nuts or adjustment sleeves, it is possible to vary the length of the lifting spindle and to adapt the requirements correspondingly. In order to be able to transfer a corresponding torque to the threaded rod, such lifting spindles are provided with a handle which can rotate about the axis of the threaded rod, which can engage with a tension pin fixed on the threaded rod. By rotating the handle, an improved lifting effect is attained, which should simplify the rotation of the threaded rod.

Such handles are used in the suspension devices of John Deere agricultural tractors and are, for example, disclosed in the spare parts catalogues for the 6020 Series tractors (Catalogue 4348, Grid 6/4, Group 71, page 42, Part Number: AL77854). The handle is made of two flat metal plates welded together, which have a bulge formed along one axis in which the threaded rod of a lifting spindle arrangement is held. The fabrication of the handle proves to be material-intensive and expensive.

The basic problem of the invention is specifying a handle of the initially mentioned type, which can be produced with less material and at lower cost.

The problem is solved in accordance with the invention by the teaching of Patent claims 1, 8, or 11. Advantageous developments and refinements of the invention can be deduced from the subordinate claims.

In accordance with the invention, a handle of the initially mentioned type is provided with bulges, arranged along the axis one behind the other, where at least one of the adjacent bulges is shaped in the opposite radial direction with respect to the axis. By shaping the bulges in this way, there is the possibility of forming the handle in one single manufacturing step by a shaping process, for example, in a deep-drawing press or a drawing and stretching press or also in a deep-forge die. Preferably, three successively arranged bulges are provided, of which the middle one is shaped in the radially opposite direction with respect to the axis relative to the other two bulges. The bulges opposite one another form, in part, a cavity around the axis with a prespecified radius, so that the axis is partially and alternately enclosed on opposite sides. In this way, a holding area is formed, for example, to hold a rod-shaped or tubular body, on which the handle is radially fixed and perhaps supported so that it can turn and slide axially. Preferably, the handle is made of flat steel as a single part. For example, a steel plate can be used for the purpose, which has a corresponding thickness and strength, so as to transfer to the rotating body the required torque. By a suitable forming device, such as a deep-drawing press or a drawing and stretching press or a deep-forge die, it is possible to shape the plate in one operation to form a handle with a corresponding holding area. By producing the handle as a single part, additional measures are omitted, such as welding or riveting, as is disclosed in the state of the art. At the same time, the expenditure of material is thereby reduced to that for a single part.

A recess is provided in the area of at least one bulge, which is open at one edge of the bulge. The recess is suitable for moving into a meshing or locking position with a projection which is fixed on a rotating body held by the handle. By rotating the handle about its axis, it is possible to transfer to the rotating body a lifting effect and thus a torque.

The bulges on the handle can be shaped in one or several stages, so that the bulges are shaped, for example, with a first and a second elevation, which, in fact, follows the first elevation, along the axis. The second elevation serves as a guide surface of the handle on a rotating body, wherein the first elevation forms a cavity between the handle and the rotating body. The cavity preferably has a cross sectional form which essentially corresponds to the cross sectional form of a projection found on the rotating body. The cavity makes it possible, with a corresponding radial direction of the handle, to carry out an axial displacement of the handle beyond the projection located on the rotating body.

It is also conceivable for the handle to be made of several flat steels that can be fitted into one another. Preferably, the bulges are then shaped on one side on a first flat steel, wherein a recess is provided between two bulges. A second flat steel has a correspondingly shaped, opposite bulge, which can be inserted in the recess. The second flat steel has an overlap with the first flat steel on edge areas of the recess. By inserting the bulge shaped on the opposite side into the recess, the overlap is effected so that by taking up a rotating body into the bulge, the two flat steels are fixed relative to one another and are supported on the rotating body, so that they can turn and be displaced axially. Welding or riveting the two flat parts is superfluous. In the same way, several recesses can also be formed, which are located between more than two bulges and in which several recesses in opposite directions can be correspondingly used.

It is also conceivable for the handle to be shaped as a one-part casting. The arrangement of the bulges in accordance with the invention makes it possible for the casting process to be carried out without the use of cores, wherein the casting process can be carried out, as such, in a particularly simple manner.

For better operating capacity, the edges of the handle, which extend parallel to the axis, can be flanged. On the one hand, sharp edges can be avoided in this way; on the other hand, the firm grip of the handle can be enhanced in this manner and a slipping of the operating hand when applying a lifting force is avoided.

In another development of the invention, it is possible to construct the bulges over an axis circumference of slightly more than 180° (for example, 185°). This would have the advantage that already with two successive bulges, a sufficient fixing of the handle to a rotating body would be possible, since a clamping effect would be achieved by enclosing the rotating body by more than 180°. A bulge formed with more than 180° makes it possible even to dispense with a second opposite bulge, if with the one bulge, a sufficient clamping effect could already be achieved. Such a formation of a handle is an exclusive invention.

A handle in accordance with the invention is preferably used on a lifting spindle arrangement. The lifting spindle arrangement usually has a rotating body, which, for example, can be a threaded rod or spindle. By rotating the threaded rod relative to one or more nuts or threaded sleeves, it is possible to change the length of the lifting spindle. The threaded rod can be equipped on one end area with right-handed threads and, on another end area with a left-handed threads, and thus mesh simultaneously on two nuts. The lifting spindle, however, can also be constructed with an adjusting sleeve as a rotating body, wherein the adjusting sleeve meshes on one or two sides with a torsion-proof threaded rod or spindle. In accordance with the development of the lifting spindle arrangement, the handle is conducted via the rotating body during the assembly of the lifting spindle, wherein the handle is supported by the bulges on the rotating body so that it can be displaced and rotated axially. A handle in accordance with the invention can be used also in a lifting spindle arrangement with a rotating body with a polygonal or oval shape. The handle is then provided with bulges with corresponding polygonal or oval shapes. The handle may be supported on the rotating body so that it can be displaced axially.

The rotating body is preferably provided with a radially protruding projection. In accordance with the development of the projection, the construction of the recess located on the handle preferably takes place in such a manner that the handle can be meshed with the projection by the radial alignment of the recess with the projection and the axial displacement with the projection. By meshing the recess on the handle with the projection, a torque can be transferred from the handle to the rotating body. With a round shape of the bulges, a torque transfer preferably takes place by a recess and projection. A multistage production of the bulges preferably takes place so that the handle can be displaced axially with a radial alignment of the first elevation with the projection. With a polygonal or oval shape of the bulges, the torque transfer takes place by the polygonal or oval shaping of the bulge, so that an arrangement of the recess and the projection can be dispensed with.

Preferably, the projection of cylindrical bolt, tension pin, splint, or the like, extends through a borehole transverse through the rotating body, wherein the projection can extend radially on one or both sides of the rotating body. It is also conceivable to produce the projection in another manner, for example, by a clamp affixed to the rotating body, or by an adjusting spring introduced into the rotating body.

A handle in accordance with the invention is preferably produced by shaping flat steel. To this end, a shaping device is suitable, such as a press or a drop-forge die. For example, a deep-drawing press or a drawing and stretching press, which has a first and a second molding, are used. In this way, the bulges can be produced in a single step, or also in several steps.

With the aid of the drawing, which shows several embodiment examples of the invention, the invention and the advantages and advantageous refinements and developments of the invention are described and explained in more detail below.

Shown are:

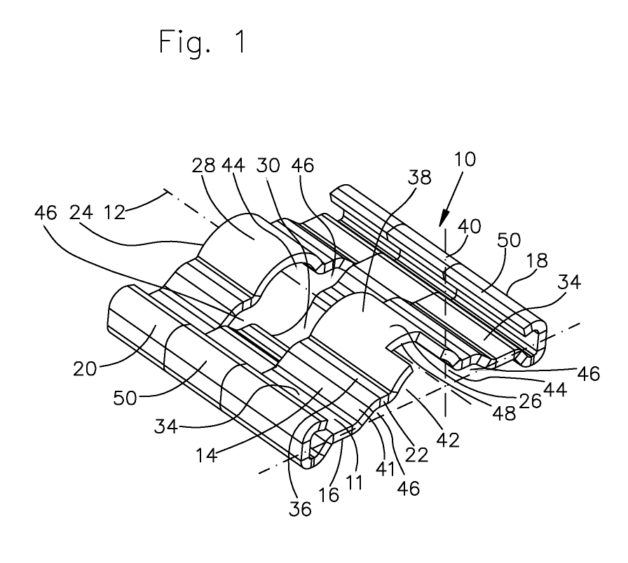

FIG. 1, a perspective view of a side surface of a handle in accordance with the invention;

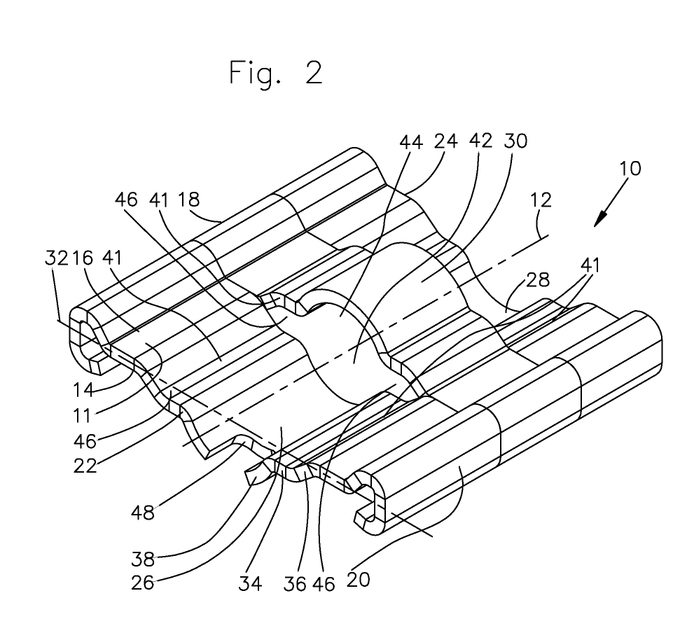

FIG. 2, a perspective view of the opposite side surface of the handle from FIG. 1;

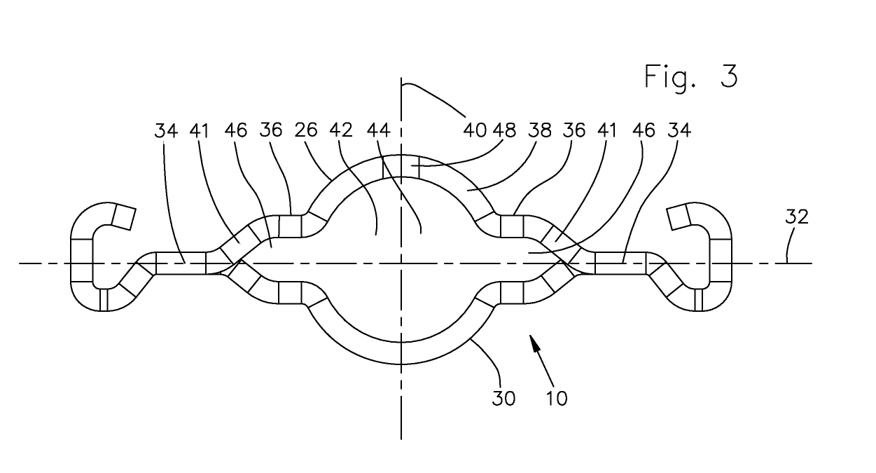

FIG. 3, a side view of the handle from FIGS. 1 and 2 in a state mounted on a rotating body;

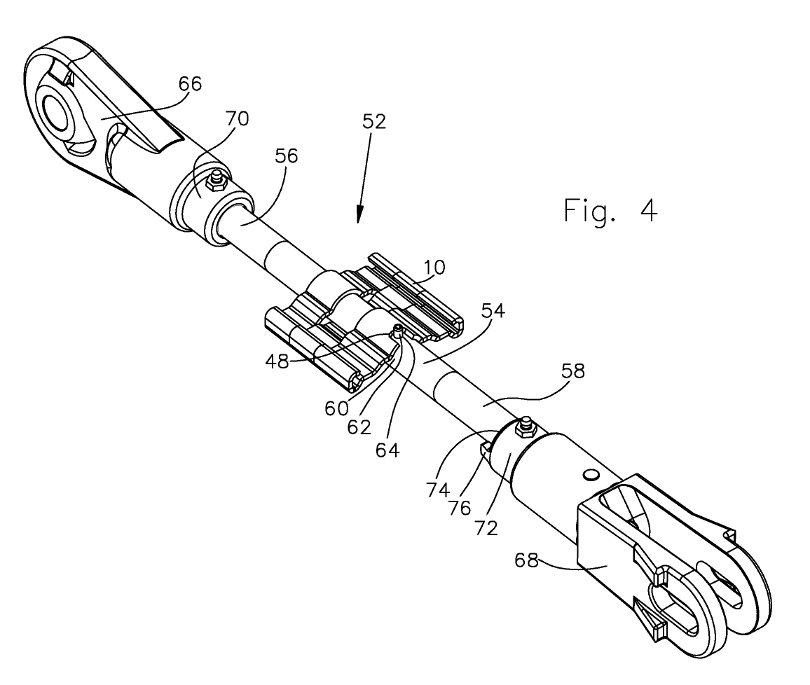

FIG. 4, a perspective view of a lifting spindle arrangement with a handle in accordance with the invention;

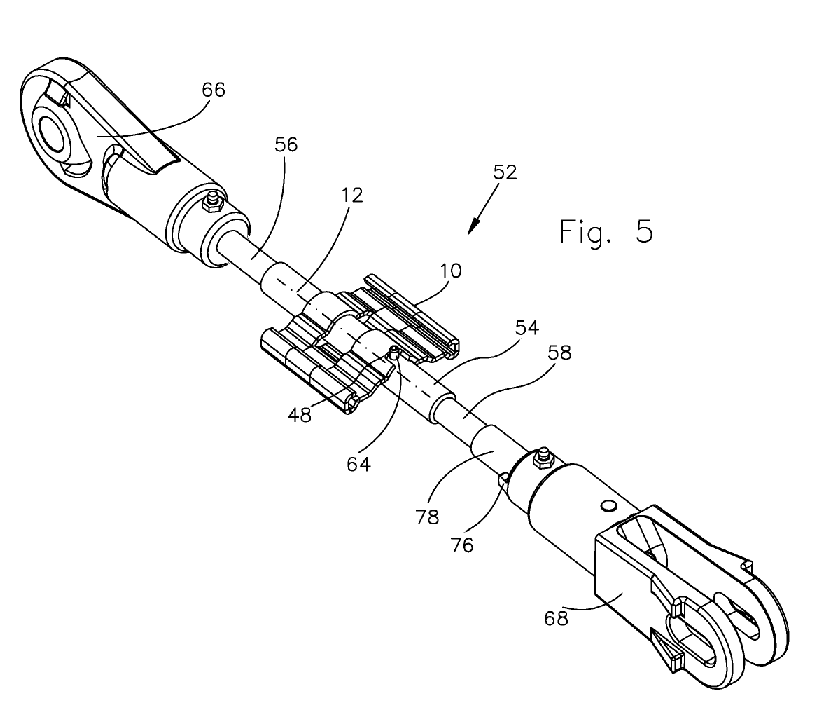

FIG. 5, a perspective view of a lifting spindle arrangement in another embodiment with a handle in accordance with the invention;

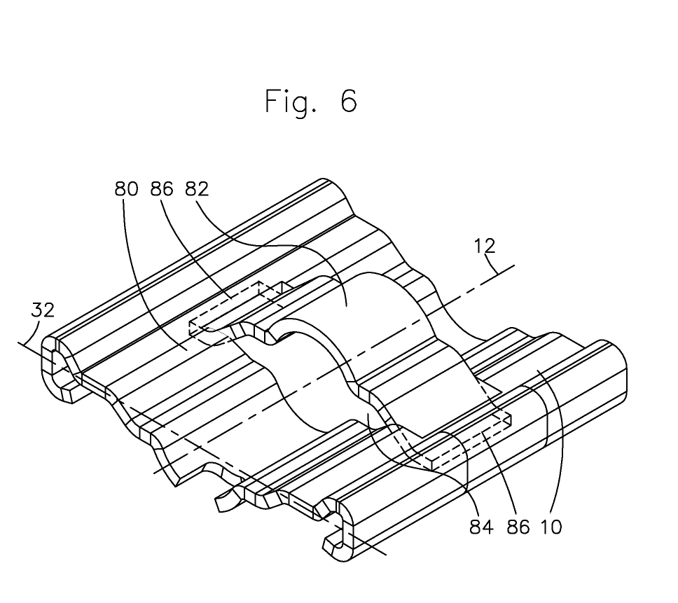

FIG. 6, a perspective view of a side surface of a handle in accordance with the invention in another embodiment;

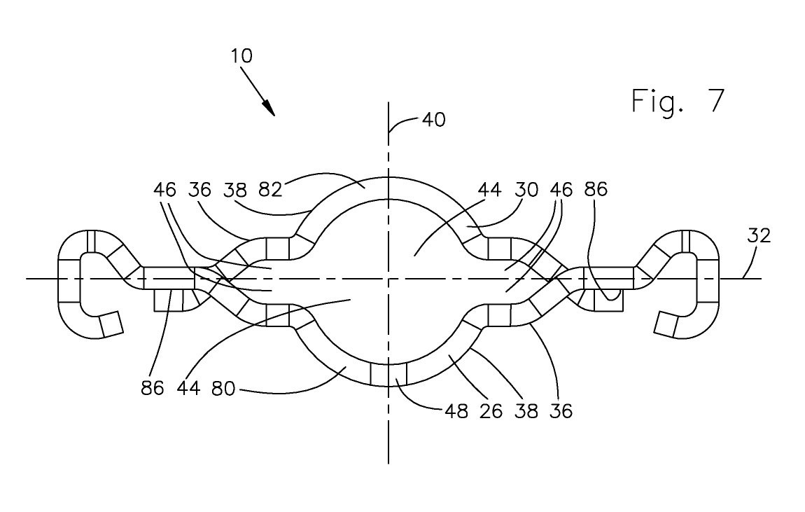

FIG. 7, a side view of the handle from FIG. 6;

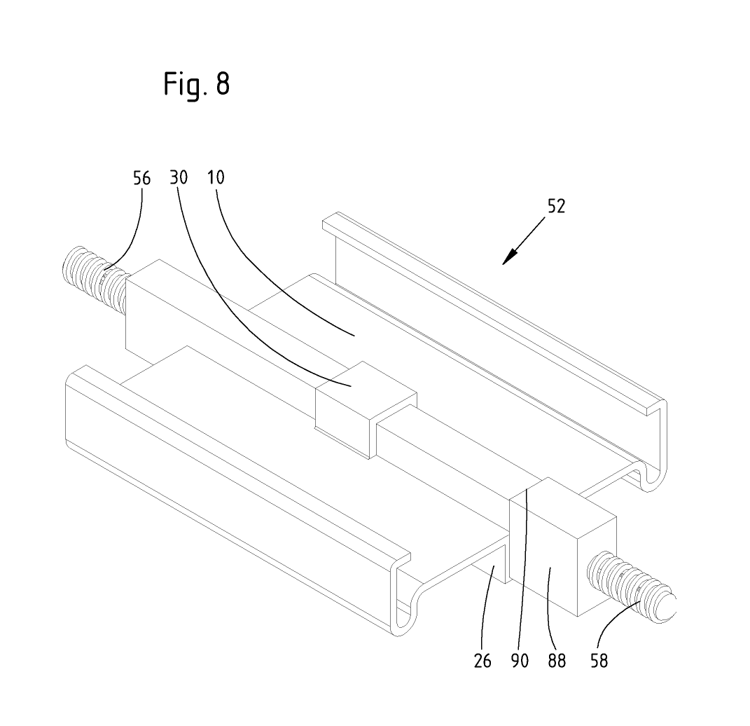

FIG. 8, a perspective view of a lifting spindle arrangement in another embodiment with a handle in accordance with the invention;

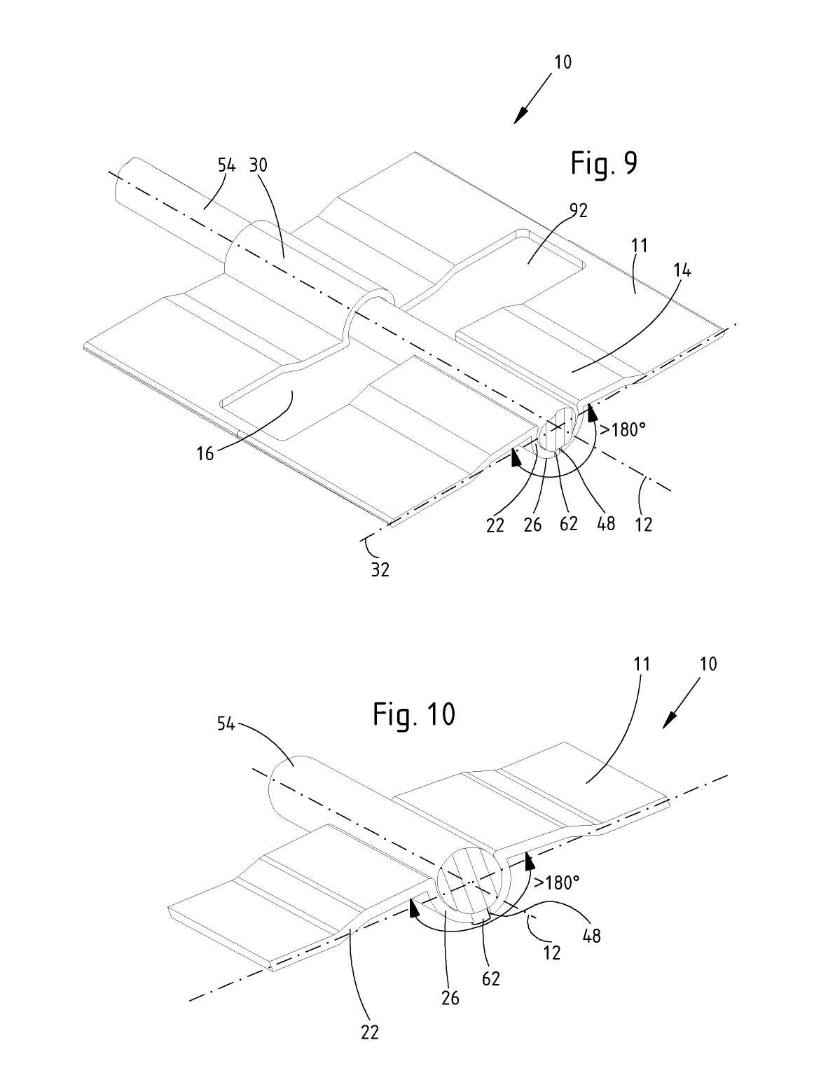

FIG. 9, a perspective view of a rotating body in connection with another embodiment of a handle in accordance with the invention; and

FIG. 10, a perspective view of a rotating body in connection with a clamping handle.

FIG. 1 shows a handle 10, which is made from a rectangular piece of flat steel 11, for example, a sheet-metal profile. The handle 10 has an axis 12, first and second side surfaces 14,16, first and second side edge areas 18, 20, and first and second end edge areas 22, 24.

A first and a second bulge 26, 28 is formed on the first side surface 14. A third bulge 30 is formed on the second side surface 16 (see, in particular, FIG. 2), wherein the third bulge 30 is situated between the first and the second bulge 26, 28 in this embodiment example and extends in the direction opposite from the first and the second bulges 26, 28.

The bulges 26, 28, 30 are constructed symmetrical to the axis 12, although in different directions—essentially, the same form as can also be seen particularly in FIGS. 2 and 3 also. The description of the bulges 26, 28, 30 takes place below, with the aid of the first bulge 26. Proceeding from a flat steel plane 34, extending along a reference axis 32 (see also FIG. 1), the bulge 26 has a first and a second elevation 36, 38, both of which extend symmetrically to a symmetrical axis 40, aligned orthogonally to axis 12 and to reference axis 32. The first elevation essentially represents a raised plane that is superimposed on the flat steel plane 34. The second elevation 38 is essentially shaped in the form of an arc and extends from the first elevation 36, so that a gradation 41 is formed on both sides of the second elevation 38, between the first elevation 36 and the flat steel plane 34, along the axis 12. A cavity 42, extending to one side of the flat steel plane 34, is formed by the bulge 26 in the area around the axis 12 between the elevations 36, 38 and the (imaginary) flat steel plane 34. The cavity 42 is composed of a cavity 44, essentially molded through the second elevation 38 and located in the middle, relative to the axis 12, with a semicircular cross section and radially following cavities 46, essentially molded through the first elevation 36 or through the gradation 41, so that, overall, a cavity 42 is formed with a bell-shaped cross section, as can be seen particularly in FIG. 3.

The handle 10 is provided with a recess 48, which is rectangular in this case. The recess 48 is provided on the end edge area 22 of the handle 10 and extends axially and in the circumference direction of the axis 12.

The side edge areas 18, 20 are provided with a flange 50, parallel to the axis 12. The flange 50 offers the advantage that the handle 10 can be better gripped by an operator and when force is applied to the handle 10, an erroneous operation, for example, a slipping of the hands, is prevented.

With the aid of FIG. 4, a functional description of the handle 10 is given, with the example of a lifting spindle 52 for a three-point device of an agricultural tractor (not shown). The lifting spindle 52 has a rod-shaped rotating body 54, which comprises a first and second threaded area 56, 58 with threads cut opposite to each other. The rotating body 54 also has a holding area 60 in which the handle 10 can be positioned. The holding area 60 is provided with a projection 62 constructed through a tension pin. The tension pin is in a borehole 64, which extends transverse through the rotating body 54, taken up, and fixed on the rotating body 54. The lifting spindle 52 is provided with an articulated head 66 and a yoke 68, wherein the articulated head 66 and the yoke 68 have an interior threaded area 70, 72, in which the threaded areas 56, 58 of the rotating body 54 are taken up.

On its end area 74, aligned with the threaded area 58, the yoke 68 has projections 76, which extend axially toward the axis 12.

Since it is particularly difficult, under load, to rotate the rotating body 54 with one's bare hands, the rotating body 54 is provided with a handle 10, with which a lifting effect can be exerted on the rotating body 54, so that a rotating moment is transferred to the rotating body 54 by rotating the handle 10 about the axis 12. During the assembly of the lifting spindle 52, the handle 10 is pushed in such a way via the rotating body 54 that the cavities 42 or 44 are filled by the rotating body. Since the bulges 26, 28, 30 extend on both sides along the axis 12, the handle 10 is supported on the rotating body 54 so that it can be rotated and displaced axially and fixed radially relative to the axis 12.

The recess 48 on the handle 10 is constructed in such a way that it corresponds approximately to the cross section of the projection 62 and can hold it. By rotating the handle 10 about the axis 12, the handle 10 with the recess 48 is aligned with the projection 62 shaped on the rotating body 54 and meshes with the projection 62 without axial play by axial displacement. The torque that can be introduced by the operator by rotating the handle 10 is transferred via the recess 48 and the projection 62 to the rotating body 54.

The cavities 46, molded by the gradation 41, are formed in such a way that they can hold the projection 62 fixed on the rotating body 54 and form opposite opening areas for the projection 62 fixed on the rotating body 54. The projection 62 can, for example, be formed by a tension pin that runs radially with respect to the rotating body 54. The handle 10 can be pushed axially along the rotating body 54 through the cavities 46 forming the opening area for the projection 62 without the projection 62 and the handle 10 colliding. The prerequisite for this is that the handle 10 be correspondingly aligned with an axial displacement, so that the projection 62 and one of the opening areas are aligned.

The projections 76 formed on the yoke 68 serve to lock the handle 10 in an out-of-operation position. To this end, the handle 10 is perhaps initially detached from its meshing position with the projection 62 by an axial displacement and aligned, by means of rotation, in such a way that the opening areas are aligned with the projection 62. The handle 10 can be pushed axially beyond the projection 62. By aligning the recess 48 with one of the projections 76 and by the axial displacement in the direction of the yoke 68, it is possible to bring the handle 10, in its out-of-operation position, with the end area 74 of the yoke 68, to the stop.

FIG. 5 shows another embodiment of a lifting spindle 52. The lifting spindle 52 has threaded areas 56, 58, separated from one another, wherein the first threaded area 56 with the articulated head 66 and the second threaded area 58 are connected to the yoke 68 without axial play. The rotating head 54 has a tubular shape in the form of an adjusting sleeve provided with interior threads, or as a nut, in this embodiment, wherein the interior threads are shaped on opposite sides corresponding to the threaded areas 56, 58. The two threaded areas 56, 58 are connected to one another via the rotating body 54. Moreover, the rotating body 54 also has a projection 62 here. For the rotation of the tubularly shaped rotating body 54, the handle 10 is pushed on the rotating body 54 and operated in the manner described above. By rotating the rotating body 54, the length of the lifting spindle can be changed.

To lock the handle 10 in an out-of-operation position, projections 76 are provided here also on the yoke 68, wherein the yoke 68 is also provided with a recessed area 78 that is used to support the handle 10 in its out-of-operation position. The recessed area 78 essentially has a diameter which corresponds to the diameter of the rotating body 54 and extends over a length which essentially covers the first and third bulges 26, 30, so that the handle 10 can be locked, essentially free of play, in its out-of-operation position. The projections 76 also formed on the yoke 68 can also be shaped on the articulated head 66. In this case, the handle 10 would be located with its recess 48 in the direction of the articulated head 66.

In FIGS. 6 and 7, another embodiment of a handle 10 in accordance with the invention is shown. Here, the handle 10 is formed by a first and a second flat steel 80, 82. The flat steel 80 essentially has the same form and design as the flat steel 11, shown in FIGS. 1 and 2—except that the flat steel 80 is provided with a rectangular recess 84 in the area and instead of the third bulge 30 from FIGS. 1 and 2. The second flat steel 82 is essentially shaped in accordance with the bulge 30, omitted from FIGS. 1 and 2. The gap 84 and the second flat steel 82 are adapted to one another in such a way that there is an overlap 86 in the area of the flat steel plane 34, on both sides of the axis 12, so that the two flat steels 80, 82 can fit into one another and thus produce a development which is essentially comparable to that from FIGS. 1 and 2. As soon as the handle 10 is pushed onto a rotating body 54, the two flat steels 80, 82 are connected to one another in a non-detachable way and can be supported so that they can turn on the rotating body 54, can be displaced axially, and can be locked, in the same way as already described above.

Even if the invention were to be described with the aid of several embodiment examples, other versatile alternatives, modifications, and variants, which are subsumed into the invention under consideration become accessible to the specialist in light of the preceding description and the drawing. Thus, for example, the shaping of the bulges 26, 28, 30 can also be made in a polygonal manner, as is shown in FIG. 8, so that the handle 10 can be supported on a rotating body 88, which has a congruent polygonal outside cross section. The polygonal shaping of the bulges 26, 28, 30, and the polygonal outside cross section of the rotating body 88 are adapted to one another in such a way that a connection without axial play already takes place as soon as the handle 10 is pushed onto the rotating body 88. The rotating body 88 is provided with a slight offset 90 in the area of the polygonal outside cross section. The offset 90 is used for the axial fixing of the handle 10. In this variant, the development of a recess 48 on the handle 10 and that of a projection 62 on the rotating body 88 for the transfer of torque to the rotating body 54 are thus superfluous. Moreover, the cavities 44 formed lateral to the axis 12, which would form an opening area for a projection 62, are also omitted. Furthermore, the projections 76 shown in FIG. 4 and the recessed area 78 are also omitted.

Moreover, the omission of a shaping process of flat steel 11, 80, 82 and the manufacture of the handle 10 as a casting are also conceivable. This would be advantageous since by the successive shaping of the bulges 26, 28, 30, a casting process can be carried out without the use of expensive casting mold cores.

Other variants of a handle 10 are shown in FIGS. 9 and 10. FIG. 9 shows a handle 10, which has only two shaped bulges 26, 30, wherein the bulges 26, 30 enclose the axis 12 of the rotating body 54 by more than 180°, and thus represent a type of clamping function. The rotating body 54 also has a projection 62 here. A corresponding gap 48 to hold the projection 62 is provided in the end edge area 22 of the bulge 26. A rectangular gap 92 is provided between the bulges 26, 30, in the middle, relative to the handle 10. The gap 92 extends in a radial direction with respect to the axis 12 up to the range of the flat steel plane 34 and has a length in the axial direction toward the axis 12, which corresponds approximately to the diameter of the rotating body 54. On the one hand, the gap 92 is used as a separation line between the bulges 26, 30, shaped in different directions, and as an opening area for the projection 62, wherein the handle 10 can be displaced axially by aligning the projection 62 in an area outside the bulges 26, 30. The handle can be displaced axially by conducting the projection 62 initially on a side surface 14, opposite the one bulge 28, to the gap 92; then the handle 10 is rotated 180°; and the projection 62 is conducted along the other side surface 16, opposite to bulge 30. On the other hand, the bulge 92 is required for mounting the handle 10 on the rotating head 54. The handle 10 is thereby pushed with the gap 92 over the rotating body 54; and the bulges 26, 30 are clamped by a tilting movement of the handle 10 on the rotating head 54. Depending on the plate thickness of the flat steel 11 or depending on the enclosing angle of the bulges 26, 30, this clamping function and thus the halting of the handle 10 on the rotating body is effected more or less strongly on the rotating head 54. A correspondingly strong execution of the clamping function can also produce a sufficient rotating closure or a connection without axial play between the handle 10 and the rotating body 54, so that one can dispense with the gap 48 and the projection 62. This would be, however, at the expense of axial displacement.

Another embodiment example in the form of a clamping handle is given in FIG. 10. Here, only one bulge 26 on the handle 10 is formed, which, likewise, due to a correspondingly large enclosure angle (enclosure angle>180°), has a corresponding clamping function and, is clamped, for example, by means of a mounting tool or by a correspondingly powerful pressing on the rotating body 54. The contact pressure of the bulge 26 provides, here, for a correspondingly torsion-free connection between the handle 10 and rotating body 54, wherein a projection 62 with a gap 48 can be placed in a manner, which was described above, so as to bring about a transfer of torque.

1. Handle with bulges (26, 28, 30), shaped parallel to an axis (12), which at least partially form a cavity (42, 44, 46) around the axis (12), characterized in that the bulges (26, 28, 30) are arranged along the axis (12) one behind the other, wherein at least one bulge (26, 28, 30) is formed in the opposite direction to an adjacent bulge (26, 28, 30), radially with respect to the axis (12).

2. Handle according to claim 1, characterized in that at least one bulge (26, 28, 30) is provided with a gap (48).

3. Handle according to one or more of the preceding claims, characterized in that the bulges (26, 28, 30) are formed in at least two steps.

4. Handle according to one or more of the preceding claims, characterized in that it is produced from several pieces of flat steel (80, 82), which can fit into one another.

5. Handle according to one or more of the preceding claims, characterized in that it is made as a casting.

6. Handle according to one or more of the preceding claims, characterized in that it has side edge areas (18, 20) provided with a flange (50).

7. Handle according to one or more of the preceding claims, characterized in that the bulges (26, 28, 30) enclose a cavity (42, 44, 46) by more than 180°.

8. Lifting spindle arrangement with a rotating body (54), characterized in that a handle (10), according to one or more of the preceding claims, is provided on the rotating head (54), wherein the bulges (26, 28, 30) of the handle (10) are meshed with the rotating body (54) so that they can rotate and can be displaced axially.

9. Lifting spindle arrangement according to claim 8, characterized in that a projection (62) is provided on the rotating body (54) and the handle (10) can be engaged with the projection (62) by a radial alignment of the gap (48) with the projection (62) and an axial displacement along the axis (12).

10. Lifting spindle arrangement according to claims 8 and/or 9, characterized in that the projection (62) is formed by a tension pin, which extends transverse to the axis (12).

11. Production method for a handle (10) according to one or more of claims 1-3, characterized by the shaping of a piece of flat steel (11, 80, 82) with a shaping device, which has a first and a second shaping body, wherein the first and the second shaping bodies have developments which extend in opposite directions, wherein the developments have forms essentially corresponding to the bulges (26, 28, 30) of the handle (10) and wherein the bulges (26, 28, 30) of the handle (10) are shaped in the piece of flat steel (11, 80, 82) in a single shaping step by pressing together the shaping bodies.
